(19) United States
(12) Patent Application Publication
(10) Pub. No.: US 2013/0050610 A1
(43) Pub. Date: Feb. 28, 2013

(54) LIQUID CRYSTAL DISPLAY

(71) Applicants: Lesley Anne PARRY-JONES, Courtenay (GB); Diana Ulrich KEAN, Oxfordshire (GB)

(72) Inventors: Lesley Anne PARRY-JONES, Courtenay (GB); Diana Ulrich KEAN, Oxfordshire (GB)

(73) Assignee: SHARP KABUSHIKI KAISHA, Osaka (JP)

(21) Appl. No.: 13/215,328

(22) Filed: Aug. 23, 2011

(51) Int. Cl. G02F 1/13357

(52) U.S. Cl. 349/62

(57) ABSTRACT

A liquid crystal display is provided which includes a combination including a liquid crystal layer located between an entrance polarizer and an exit polarizer; a backlight configured to illuminate the combination on a side of the liquid crystal layer which includes the entrance polarizer for viewing by an observer on a side of the liquid crystal layer which includes the exit polarizer; and an additional optical element which is positioned between the entrance polarizer and the exit polarizer and is configured to provide additional functionality and/or improved display performance in the display.

### TECHNICAL FIELD

This invention relates to transmissive liquid crystal displays which create an image using polarization optics, and in addition have an additional optical element such as a microlens array positioned somewhere between the entrance and exit polarizers, for the purpose of increased display functionality or performance. Specifically, this invention discloses methods of arranging the polarizers, compensation films, liquid crystal layer and an additional optical element in such a way as to minimize the impact of the additional optical element on the contrast ratio and/or viewing angle of the display.

### BACKGROUND ART

Liquid crystal displays (LCDs) such as those used in flat panel televisions and portable information devices, are capable of extremely high contrast ratios in excess of 3000:1. In most cases, the image is formed by making use of the birefringent properties of the liquid crystal. FIG. 1(a) shows the basic principle of a transmissive LCD which works based on polarization optics. A liquid crystal layer (1) lies between an entrance polarizer (2a) and an exit polarizer (2b). The combination is illuminated on one side of the liquid crystal layer (1) which includes the entrance polarizer (2a) (the “entrance”) by a backlight (3), and viewed from the other side of the liquid crystal layer (1) which includes the exit polarizer (2b) (the “exit”) by an observer (4). Optical contrast between bright parts of an image and darker parts is obtained by applying a position sensitive voltage to the liquid crystal (LC) layer (1). In general, it is possible to achieve very high contrast ratios using this simple arrangement for an observer positioned at normal incidence to the display (4a), as illustrated in FIG. 1. However, because of the anisotropic nature of the liquid crystal layer (1), the contrast ratio is often lower when observed at oblique incidence (4b). For that reason, the general structure of an LCD is often as illustrated in FIG. 1(b). FIG. 1(b) differs from FIG. 1(a) in that there are extra compensation films (5) (entrance and exit compensation films 5a and 5b, respectively) between the LC layer (1) and the polarizers (2). The purpose of the compensation films is to compensate for the viewing angle properties of the LC layer 1 (usually in the black state) and hence to improve the contrast ratio of the display at oblique incidence.

In general, such compensation schemes are relatively straightforward, as all that is required is that the compensation films (5) correct for any non-ideal properties of the liquid crystal layer (1) and/or polarizers (2) when viewed at oblique incidence. The limit of the contrast ratio is determined by the relative dispersion of the liquid crystal and compensating materials, manufacturing tolerances, and scattering from other elements inside the display, such as spacer balls, colour filters and drive electronics such as pixel electrodes and thin-film transistors (TFTs).

So far, we have described a typical LCD such as may be used on a flat panel television or a mobile phone. In general, the display is considered of high quality if it can be observed with good brightness and contrast ratio at all angles of incidence, by many users, and if the quality of the image is independent of viewing angle. However, there are some examples of cases in which one would like the image not to be observable from all angles of incidence, or for the image to appear different from different viewing angles. For example, it may be desirable for a laptop screen to display an image only at normal incidence, so that confidential work can be undertaken on a busy train without fear of disclosing important information to an observer at oblique incidence (i.e., privacy view). Another example is a dual view display in the center console of an automobile: the driver sees GPS information whilst the front seat passenger can watch a movie. A further example is a low power television which saves power by directing light only towards the observer. A yet further example is a 3D display.

In these cases, extra optical elements are often required within the display in order to either redirect or block the light emerging from the display. It is very often the case that these extra optical elements are needed to be in close proximity to the pixels of the LCD in order to create the required parallax or beam steering effect. Because of the close proximity required, the optical elements will often need to be placed between the polarizers of the LCD. For example, FIG. 2 shows a typical example of a system that might be used in order to create the privacy and dual view effects described in the previous paragraph. Here, the arrangement of the various layers is identical to that shown in FIG. 1(b), except that there is an additional optical element (6) between the LC layer (1) and the exit compensation film (5b). In general the additional optical element (6) could include any refractive, reflective, diffractive or absorbing element.

As described above, the introduction of such extra optical elements into the display can make the display more versatile either by providing additional functionality or by improving brightness or saving power. However, the introduction of such extra optical elements (if they are between the polarizers of the LCD) can impact on the contrast ratio (and hence the image quality and viewing angle properties) of the display.

There are several reasons for the impact of the extra optical elements on the contrast ratio of the display, and these are illustrated in FIG. 3, using the example of an array of microlenses as the extra optical element.

FIG. 3(a) shows in detail the refraction of a ray of light as it travels through a single microlens made of a medium of higher refractive index than that of its surroundings. In general, the transmission coefficient for light polarized parallel (p) and perpendicular (s) to an interface between two media of differing refractive index is different, and hence the polarisation of light will change both on entering and exiting the microlens. Therefore, in general, both the angle of propagation and the polarisation of light emerging from the microlens will be different to that entering the microlens, hence the polarisation of light striking the exit compensation film (5b) or exit polarizer (2b) will not be the same as if the microlens was not there. The compensation will in general not function exactly as it was designed to do if the microlens array was absent, and as a result the contrast ratio will generally drop.

A further mechanism by which the contrast ratio of an LCD is affected by a microlens array is illustrated in FIG. 3(b). The same mechanism that causes the change in polarisation of a ray transmitted through any interface between two media of differing refractive index also gives rise to reflected rays which lead to multiple reflections within the device. FIG. 3(b) shows an example of a multiply-reflected ray path that can occur within the layer of material surrounding the microlenses of a microlens array, which must necessarily be of a different refractive index to the microlenses (in order for them to have a beam-steering effect). In general, there will be a polarisation change at every reflection, and hence multiply-reflected rays that eventually emerge from the display will in general be of a different polarisation to the ray which is transmitted straight through without any reflections, leading to a drop in contrast ratio.

FIG. 3(c) shows another mechanism by which the contrast ratio is affected by the microlens array (representing the additional optical element (6)). There, it is illustrated how the light that reaches the observer (4) is a combination of a number of rays that have travelled through the entrance polarizer (2a), entrance compensation film (5a) and liquid crystal layer (1) at a variety of different angles of incidence, and the microlens has diverted them to the angle of viewing determined by the observer. Of course the rays have different weighting in terms of power, according to the properties of the microlens array (6). However, it is clear that the light reaching the exit compensation film (5b) can consist of a mixture of different polarisations, and in that case the compensation film (5b) of course cannot compensate correctly for all of those polarisations. As a result, the contrast of the display will in general drop.

The possible mechanisms by which an additional optical element such as a microlens array can affect the contrast ratio of a display have been described here for the case that the additional optical element is a microlens array. However, the mechanisms are equally applicable to other optical elements such as other refractive optics, louvres, parallax barriers or diffractive optics.

Here, we have described why microlenses, or other optical elements, might be useful in an LCD to create added functionality. We have also explained a number of ways in which the introduction of such optical elements between the polarizers of a display can reduce the contrast ratio of the LCD. It is the purpose of this invention to describe methods by which a microlens LCD (or LCD with other optical elements) can be designed so that the optical elements have little or no effect on the contrast ratio of the display.

The use of microlenses or other optical elements in conjunction with LCDs is not uncommon. For example, EP 0791 847 A1 (Van Berkel et al., pub. Aug. 27, 1997) and WO 03/015424 A2 (Woodgate et al., pub. Feb. 20, 2003) describe the use of microlenses in order to create a 3D display. However, the microlens array is positioned outside the polarizers of the LCD, i.e. the image is already formed before the light enters the microlens array. Therefore, there is not the problem with loss of contrast associated with having the microlens array between the polarizers of the LCD as described above. This is very often the case with displays which are designed for 3D, because for the typical range of pixel sizes, and for the typical range of viewing distances, the separation required between the pixels of the LCD and the microlens array is usually large enough to allow for an external polarizer in between the pixels and the microlens array. This is not always the case for displays designed for other applications, such as Dual View or privacy, because for these applications it is generally necessary to steer the light emitted from the pixels through a much larger angle. This in turn generally requires a smaller separation between the pixels and the microlens array, and hence it is often not possible to place an external polarizer in this space, necessitating the microlens array to be positioned between the polarizers of the LCD.

There are some examples of 3D displays in which the microlens array is positioned between the polarizers, for example, as also disclosed in WO 03/015424 A2. However, this patent publication does not mention a loss in contrast ratio which occurs as a result of placing the microlens array between the entrance and exit polarizers of the display, nor does it mention any particular measures in which to minimize or eliminate any such loss in contrast ratio.

Patent publication US 2010/0039583 A1 (Usukura, pub. Feb. 18, 2010) describes the use of microlenses between the polarizers of an LCD in order to increase light throughput through the pixel apertures of the display. The publication discloses a number of measures which can be taken in order to maintain high contrast ratio in the display. However, the publication is restricted to the case in which the microlenses are placed between the entrance compensation film and the LC layer, and does not consider the case where the microlenses are between the LC layer and the exit compensation film. Neither does it consider the case of different optical elements, such as prisms, reflectors, diffractive elements or absorbers.

### SUMMARY OF INVENTION

This invention refers to a number of different ways in which the contrast ratio of a transmissive liquid crystal display which creates an image using polarization optics, and therefore incorporates a liquid crystal layer positioned between entrance and exit polarizers, and which uses an additional optical element, such as a microlens array, other refractive optics, louvres, parallax barriers or diffractive elements, either for the purposes of increased display functionality, or for improved display performance, can be optimized in order to minimize the impact of the additional optical element on the contrast ratio and/or viewing angle of the display.

According to one aspect of the invention, this involves the use of single-sided compensation films where the compensation film is placed on the opposite side of the liquid crystal layer to the additional optical element. Another aspect of the invention involves the use of internal retarders and/or polarizers in order to reduce the effect of the additional optical element. A further aspect of the invention involves the use of particular polarizer orientations with respect to the axes of symmetry of the additional optical element. A still further aspect of the invention involves aligning the absorption axes of the polarizers with the principle viewing plane(s) of the display. A still further aspect of the invention involves the use of particular liquid crystal alignment geometries that result in either very little polarization change of light as it passes through the liquid crystal layer (either in the zero volts state or when voltage is applied), or a change in polarization that is relatively independent of the angle of incidence of the light.

In accordance with an aspect of the present invention, a liquid crystal display is provided which includes a combination including a liquid crystal layer located between an entrance polarizer and an exit polarizer; a backlight configured to illuminate the combination on a side of the liquid crystal layer which includes the entrance polarizer for viewing by an observer on a side of the liquid crystal layer which includes the exit polarizer; and an additional optical element which is positioned between the entrance polarizer and the exit polarizer and is configured to provide additional functionality and/or improved display performance in the display.

According to another aspect, the display includes a compensation film on only a single side of the liquid crystal layer, the single side being the side of the liquid crystal layer which is opposite the side of the liquid crystal layer on which the additional optical element is located.

In accordance with another aspect, the additional optical element is positioned between the liquid crystal layer and the exit polarizer, and the compensation film is located on the side of the liquid crystal layer which includes the entrance polarizer.

According to yet another aspect, the compensation film compensates a dark state of the liquid crystal layer so that there is substantially no net change in polarization of light as the light propagates through a combination of the compensation film and the liquid crystal layer.

In accordance with still another aspect, the dark state of the liquid crystal layer consists of a uniform molecular alignment.

According to another aspect, the dark state of the liquid crystal layer is a homeotropic or homogeneous state as used in VAN (“Vertically Aligned Nematic”), IPS (“In-Plane Switching”), FFS (“Fringe-Field-Switching”) and ECB (“Electrically Controlled Birefringence) mode liquid crystal displays.

According to still another aspect, the compensation film is substantially equal and opposite in terms of retardation value to that of the liquid crystal layer in the dark state.

In accordance with yet another aspect, the liquid crystal layer is configured in a VAN mode, and the compensation film is a negative c-plate of substantially equal and opposite value to a positive c-plate represented by the liquid crystal layer in the dark state.

According to another aspect, the liquid crystal layer is configured in an IPS, FFS or ECB mode, and the compensation film is a negative a-plate of substantially equal and opposite value to a positive a-plate represented by the liquid crystal layer in the dark state.

According to still another aspect, the display includes compensation films on both sides of the liquid crystal layer with the compensation films not being symmetric.

In accordance with another aspect, the additional optical element is positioned between the liquid crystal layer and the exit polarizer and the display includes a compensation film placed between the liquid crystal layer and the additional optical element.

According to another aspect, the liquid crystal layer is maintained between an entrance substrate and an exit substrate, and the compensation film is adhered to an outside of the exit substrate.

According to still another aspect, the liquid crystal layer is maintained between an entrance substrate and an exit substrate, and the compensation film is situated between the exit substrate and the liquid crystal layer.

In yet another aspect, the compensation film is created using reactive mesogens.

In still another aspect, the display further includes an internal polarizer between the compensation film and the exit substrate.

According to another aspect, the display further includes another compensation film on the side of the liquid crystal layer which includes the entrance polarizer.

According to still another aspect, the additional optical element is located between the liquid crystal layer and the exit substrate.

In accordance with another aspect, the liquid crystal layer exhibits one or more of homeotropic alignment, parallel planar alignment, anti-parallel planar alignment, hybrid alignment and twisted planar alignment.

According to another aspect, the display has a single viewing plane which contains a display normal or the display has two principle viewing planes which are perpendicular and both contain the display normal, and wherein absorption axes of the entrance polarizer and the exit polarizer are substantially parallel or perpendicular to each other.

In still another aspect, the additional optical element has complete translational symmetry in one direction parallel to the liquid crystal layer, and absorption axes of the entrance polarizer and the exit polarizer are each aligned either substantially parallel to or perpendicular to an axis of translational symmetry of the additional optical element.

In yet another aspect, the additional optical element includes an array of lenticular lenses, a striped parallax barrier or a louvre.

According to still another aspect, the additional optical element provides additional functionality of dual, 3D, or privacy view.

With still another aspect, the additional optical element provides improved display performance with respect to brightness and/or saving power

In accordance with another aspect, the additional optical element includes a microlens array, refractive optics, louvre, parallax barrier or diffractive optics.

According to another aspect, a liquid crystal display is provided which includes a combination including a liquid crystal layer located between an entrance polarizer and an exit polarizer; a backlight configured to illuminate the combination on a side of the liquid crystal layer which includes the entrance polarizer for viewing by an observer on a side of the liquid crystal layer which includes the exit polarizer; an additional optical element which is positioned on the side of the liquid crystal layer which includes the exit polarizer and is configured to provide additional functionality and/or improved display performance in the display, wherein the liquid crystal layer is maintained between an entrance substrate and an exit substrate, a compensation film is situated between the exit substrate and the liquid crystal layer, and the exit polarizer is an internal polarizer located between the compensation film and the exit substrate.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF DRAWINGS

In the annexed drawings, like references indicate like parts or features:

FIG. 1: illustration of the operation of a transmissive LCD which creates an image using polarization optics:
(a) a basic LCD comprising an LC layer (1) with two polarizers (2) either side and a backlight (3) underneath
(b) a more sophisticated LCD which also includes additional compensation films (5) between the LC layer (1) and the polarizers (2)

FIG. 2: illustration of a typical example of an LCD with an additional optical element between the polarizers: in this case it is between the LC layer (1) and the exit compensation film (2b)

FIG. 3: illustration of the ways in which an additional optical element positioned between the entrance and exit polarizers can affect the contrast ratio of a display:
(a) polarization change at refractive interfaces
(b) multiple reflections
(c) multiple angles of travel through the LC layer contributing to one viewing angle

FIG. 4: illustration of the concept of single sided compensation of the black state

FIG. 5: illustration of the use of internal retarders
(a) exit compensation film placed between LC layer (1) and additional optical element
(b) exit compensation film adhered to exit substrate of LCD
(c) exit compensation film created internally

FIG. 6: illustration of the use of internal polarizers
(a) internal polarizer between exit compensation film and exit substrate, with additional external exit polarizer
(b) internal polarizer between exit compensation film and exit substrate without additional external exit polarizer

FIG. 7(a)-7(f): illustration of various LC alignment geometries that can be used in conjunction with an additional optical element for good contrast ratio

### DESCRIPTION OF REFERENCE NUMERALS

1 LC layer
2 Polarizer
2a Entrance polarizer
2b Exit polarizer
3 Backlight
4 An observer
4a An observer at normal incidence to the display
4b An observer at oblique incidence to the display
5 Compensation film
5a Entrance compensation film
5b Exit compensation film
6 An additional optical element
7 LCD substrate
7b Exit LCD substrate
8 Alignment layer for liquid crystal
8a Homeotropic alignment layer
8b Planar alignment layer with low pretilt
8c Planar alignment layer with high pretilt
9 Liquid crystal molecule

### DETAILED DESCRIPTION OF INVENTION

A display might consist of a backlight, a rear polarizer, view angle compensation films, a liquid crystal layer, an additional optical element (such as a refracting lens or prism), and a front polarizer. In this invention, an objective is to design a display in such a way that the polarisation of the rays of light striking the front polarizer (closest to the viewer) is substantially independent of the angle of incidence of the ray through the previous parts of the display. This can be achieved in a number of different ways, as described in the following embodiments of the invention. For sake of brevity, the various embodiments of the invention are described herein in relation to the drawings in which only the layers, films, substrates, etc., of specific relevance are shown. Other layers may be included as will be appreciated.

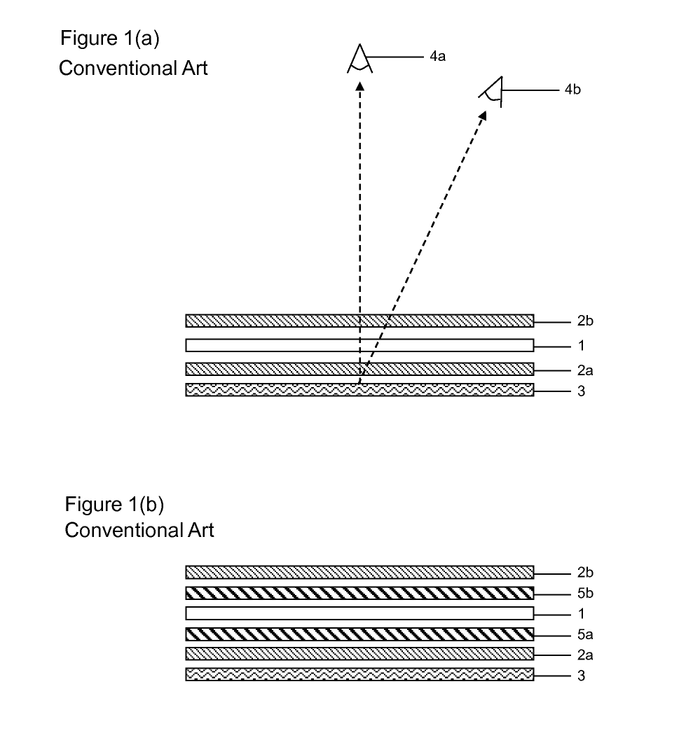

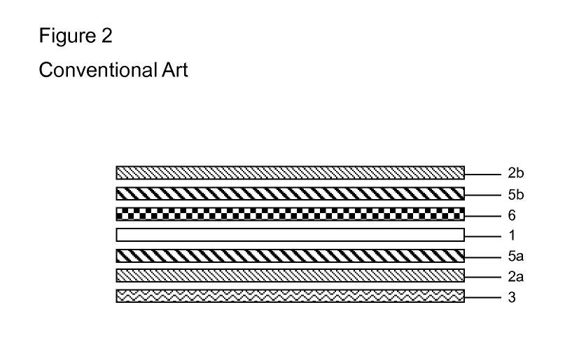

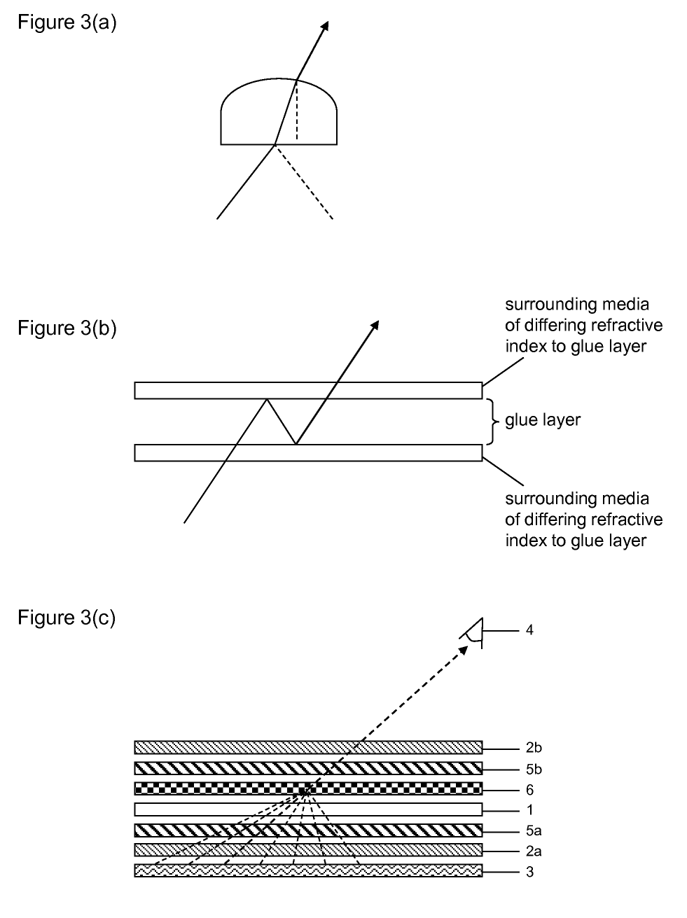

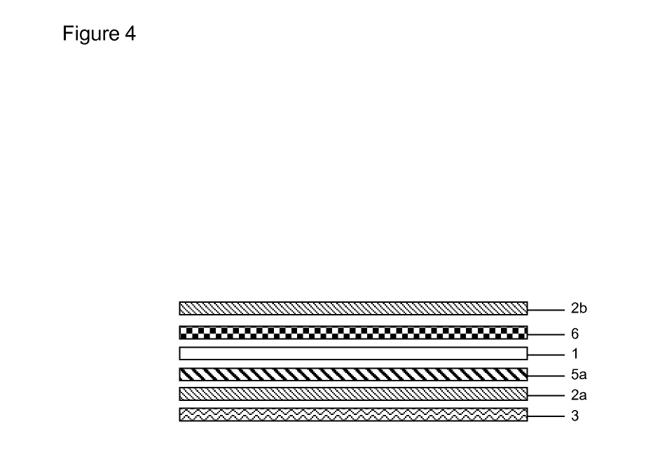

In one embodiment of the invention, the black state of the liquid crystal layer (1) is substantially compensated by the entrance compensation film (5a), i.e. when the LC layer (1) is in its dark state, there is substantially no net change in polarisation of light as it propagates through the combination of both the entrance compensation film (5a) and the LC layer (1), whereas normally this function would be performed by two compensation films (5a) and (5b) on either side of the LC layer (1), as in FIGS. 1(b) and 2. Such “single-sided compensation” is not always possible as it depends on the LC mode used. It is most effective when the dark state of the LC layer (1) consists of a uniform molecular alignment, for example, a homeotropic or homogeneous state, as used in VAN (“Vertically Aligned Nematic”), IPS (“In-Plane Switching”), FFS (“Fringe-Field-Switching”) and ECB (“Electrically Controlled Birefringence) mode LCDs, but less effective when the dark state lacks this symmetry, such as a TN (“Twisted Nematic”) or STN (Super-Twisted Nematic”) mode LCD. When single-sided compensation is possible, therefore, it is no longer necessary to have an exit compensation film (5b), as shown in FIG. 4. The remaining compensation film (5a) must compensate entirely for the LC layer (1) in a single step, and is therefore usually substantially equal and opposite in terms of retardation value to that of the LC layer (1) in the dark state. For example, in the case of a VAN mode LCD, the dark state of the LC layer (1) corresponds to homeotropic alignment, and hence the LC layer (1) is effectively a positive c-plate. The appropriate single-sided compensation film is therefore a negative c-plate of substantially equal and opposite value to that of the LC layer (1). However, in the cases of IPS (“In-Plane Switching”), FFS (“Fringe-Field-Switching”) or ECB (“Electrically Controlled Birefringence) mode LCDs, the dark state of the LC layer (1) corresponds to homogeneous alignment, and hence the LC layer (1) is effectively a positive a-plate. The appropriate single-sided compensation film is therefore a negative a-plate of substantially equal and opposite value to that of the LC layer (1).

Although it is possible in some cases (for example, those described above) to achieve near perfect optical compensation for the LC layer (1) with a single compensation film (5a), it is not always possible to compensate fully for the viewing angle dependence of the polarizers with a single compensation film on one side of the LC layer (1). Therefore, the optimum design of the entrance and exit compensation films (5a) and (5b) for the best overall contrast ratio may not be either of the two extremes of having completely symmetric compensation films, or having completely single-sided compensation as in the previous embodiment. Therefore, another embodiment of this invention is a modification to the previous one in which there are now both entrance (5a) and exit (5b) compensation films, which are not necessarily symmetric, in order to strike the best compromise between compensating for the viewing angle dependence of the polarizers, and keeping the substantial part of the compensation on the opposite side of the LC layer (1) to the additional optical element (6).

In a further embodiment of the invention, the compensation of the black state of the LC layer (1) does not necessarily need to be substantially single-sided, because the exit compensation film (5b) is placed between the LC layer (1) and the additional optical element (6), as illustrated in FIG. 5(a). This is not the conventional position of the exit compensation film (5b), as they are commonly adhered to the polarizers (2). There are two principle ways in which this could be achieved. Firstly, and illustrated in FIG. 5(b), the LC layer (1) is maintained between an entrance substrate (not shown) and an exit substrate (7b), and a compensation film (5b) could be adhered to the outside of the exit substrate (7b) of the LCD, before the additional optical element (6) and the exit polarizer (2b) are added on-top. Secondly, and illustrated in FIG. 5(c), the compensation film (5b) could be created internally to the LCD panel, i.e. so that it is situated between the exit substrate (7b) and the LC layer (1). Such an internal compensation film (5b) is usually referred to as an “internal retarder” and can be created using materials such as reactive mesogens. The entrance compensation film (5a) can either be of the conventional type, adhered to the entrance polarizer (2a), a separate, external retarder adhered to the outer surface of the entrance substrate (7a) (not shown), or an internal retarder.

In a further embodiment of the invention, the exit compensation film (5b) is also an internal retarder as described in the previous embodiment, however, there is also an internal polarizer (2c) between the exit compensation film (5b) and the exit substrate (7b). The purpose of the internal polarizer is to either fully or partially analyse the image from the display before the light strikes the additional optical element. Ideally, the image would be fully analysed, however, the quality of some internal polarizers is such that a further regular external polarizer (2b) is often needed to fully analyse the image, as in FIG. 6(a). The case where the additional external polarizer is not required, is illustrated in FIG. 6(b). The entrance polarizer (2a) can either be an external polarizer, as previously disclosed, a high quality internal polarizer, or a combination of an external polarizer and a lower quality internal polarizer. In the first of these cases, the entrance compensation film (5a) can be either external or internal, but in the other two cases it must necessarily be an internal retarder.

In the illustrations accompanying the previous two embodiments, i.e. FIGS. 5 and 6, it has been assumed that additional optical element (6) is external to the LCD display, i.e. outside the exit substrate (7b). However, it is possible that the additional optical element 6 could be created within the cell, along with any internal retarders or polarizers, or not. In the case that there is an internal additional optical element, this would change FIGS. 5(b), 5(c), 6(a) and 6(b) such that that the additional optical element (6) is immediately on the side of the exit substrate (7b) closest to the LC layer (1).

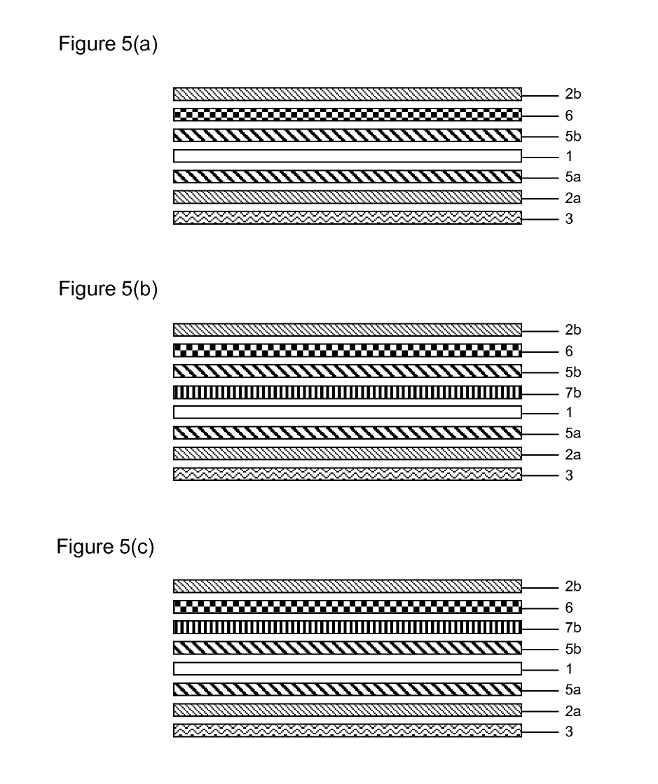

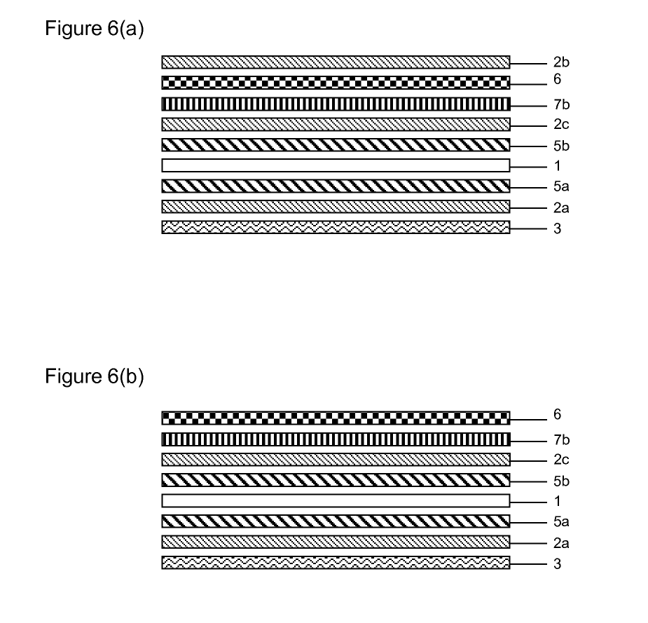

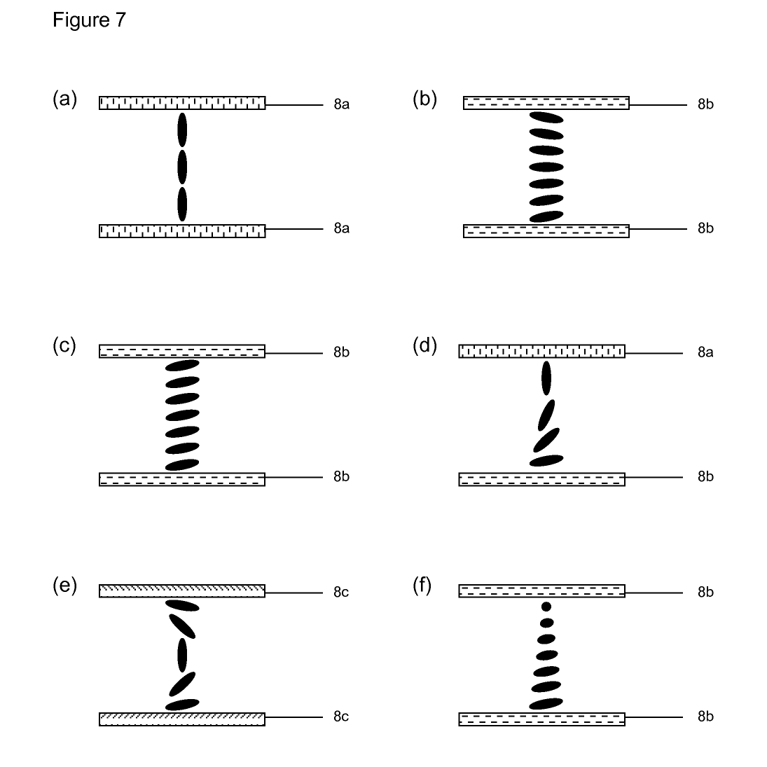

A further embodiment of the invention concerns the use of particular alignment schemes for the liquid crystal layer (1) of an LCD, when used in conjunction with an additional optical element (6) between the LC layer (1) and the external exit polarizer (2b). The particular alignment schemes covered by this embodiment are illustrated in FIG. 7. FIG. 7(a) illustrates homeotropic alignment of the liquid crystal at both surfaces between homeotropic alignment layers (8a), where the liquid crystal alignment is substantially perpendicular to the LCD substrate at both surfaces (but can have a small pretilt). FIGS. 7(b) and 7(c) illustrate parallel and anti-parallel planar alignment (respectively) at both surfaces between planar alignment layers (8b) with low pretilt, which again can have a finite pretilt. FIG. 7(d) illustrates hybrid alignment where the liquid crystal alignment is homeotropic at one surface and planar at the other between homeotropic and planar alignment layers (8a) and 8(b), respectively. FIG. 7(e) illustrates parallel planar alignment between planar alignment layers (8c) with high pretilt, in the case where the pretilt is so large that the liquid crystal adopts vertical alignment rather than horizontal alignment in the centre of the cell: this mode is often referred to as a π-state and is the basis of the OCB (optically-compensated-bend) mode. Finally, FIG. 7(f) illustrates a twisted planar alignment for the case of a 90° twist angle between the alignment directions on the two surfaces (but is not limited to that particular angle). This alignment scheme between planar alignment layers with low pretilt (8b) is the basis of the TN (twisted-nematic) mode.

A still further embodiment of the invention is concerned specifically with the case that the LCD is observed principally by viewers in a single plane which contains the display normal, or has two principle viewing planes which are perpendicular and both contain the display normal. In this embodiment, the absorption axes of the entrance and exit polarizers (2a and 2b) are aligned either substantially parallel to or perpendicular to the principle viewing plane(s). The absorption axes of the entrance and exit polarizers (2a and 2b) are therefore substantially parallel or perpendicular to each other in this embodiment.

A still further embodiment of the invention is concerned specifically with the case that the additional optical element has complete translational symmetry in one direction parallel to the liquid crystal layer. Examples of such systems include an array of lenticular lenses, a striped parallax barrier or a simple louvre. In this embodiment, the absorption axes of the entrance and exit polarizers (2a and 2b) are each aligned either substantially parallel to or perpendicular to the axis of translational symmetry of the additional optical element. The absorption axes of the entrance and exit polarizers (2a and 2b) are therefore substantially parallel or perpendicular to each other in this embodiment.

Although the invention has been shown and described with respect to a certain embodiment or embodiments, equivalent alterations and modifications may occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein exemplary embodiment or embodiments of the invention. In addition, while a particular feature of the invention may have been described above with respect to only one or more of several embodiments, such feature may be combined with one or more other features of the other embodiments, as may be desired and advantageous for any given or particular application.

### INDUSTRIAL APPLICABILITY

The invention can be applied to all transmissive LCDs that work using the principles of polarization optics, in which it is beneficial to have an additional optical element which can add extra functionality or improve display performance. Examples of extra functionality are dual view displays, 3D displays and privacy displays, or displays capable of all such functions. Examples of improved device performance are improved brightness, greater viewing angle or reduced power consumption. Such displays can be used in portable electronic devices, automobiles and other transport, desktop computer monitors, televisions and large advertising signs and billboards.

1. A liquid crystal display, comprising:
a combination including a liquid crystal layer located between an entrance polarizer and an exit polarizer;
a backlight configured to illuminate the combination on a side of the liquid crystal layer which includes the entrance polarizer for viewing by an observer on a side of the liquid crystal layer which includes the exit polarizer; and
an additional optical element which is positioned between the entrance polarizer and the exit polarizer and is configured to provide additional functionality and/or improved display performance in the display.

2. The display according to claim 1, wherein the display includes a compensation film on only a single side of the liquid crystal layer, the single side being the side of the liquid crystal layer which is opposite the side of the liquid crystal layer on which the additional optical element is located.

3. The display according to claim 2, wherein the additional optical element is positioned between the liquid crystal layer and the exit polarizer, and the compensation film is located on the side of the liquid crystal layer which includes the entrance polarizer.

4. The display according to claim 3, wherein the compensation film compensates a dark state of the liquid crystal layer so that there is substantially no net change in polarization of light as the light propagates through a combination of the compensation film and the liquid crystal layer.

5. The display according to claim 4, wherein the dark state of the liquid crystal layer consists of a uniform molecular alignment.

6. The display according to claim 5, wherein the dark state of the liquid crystal layer is a homeotropic or homogeneous state as used in VAN (“Vertically Aligned Nematic”), IPS (“In-Plane Switching”), FFS (“Fringe-Field-Switching”) and ECB (“Electrically Controlled Birefringence) mode liquid crystal displays.

7. The display according to claim 4, wherein the compensation film is substantially equal and opposite in terms of retardation value to that of the liquid crystal layer in the dark state.

8. The display according to claim 7, wherein the liquid crystal layer is configured in a VAN mode, and the compensation film is a negative c-plate of substantially equal and opposite value to a positive c-plate represented by the liquid crystal layer in the dark state.

9. The display according to claim 7, wherein the liquid crystal layer is configured in an IPS, FFS or ECB mode, and the compensation film is a negative a-plate of substantially equal and opposite value to a positive a-plate represented by the liquid crystal layer in the dark state.

10. The display according to claim 1, wherein the display includes compensation films on both sides of the liquid crystal layer with the compensation films not being symmetric.

11. The display according to claim 1, wherein the additional optical element is positioned between the liquid crystal layer and the exit polarizer and the display includes a compensation film placed between the liquid crystal layer and the additional optical element.

12. The display according to claim 11, wherein the liquid crystal layer is maintained between an entrance substrate and an exit substrate, and the compensation film is adhered to an outside of the exit substrate.

13. The display according to claim 11, wherein the liquid crystal layer is maintained between an entrance substrate and an exit substrate, and the compensation film is situated between the exit substrate and the liquid crystal layer.

14. The display according to claim 13, wherein the compensation film is created using reactive mesogens.

15. The display according to claim 13, further comprising an internal polarizer between the compensation film and the exit substrate.

16. The display according to claim 11, further comprising another compensation film on the side of the liquid crystal layer which includes the entrance polarizer.

17. The display according to claim 11, wherein the additional optical element is located between the liquid crystal layer and the exit substrate.

18. The display according to claim 1, wherein the liquid crystal layer exhibits one or more of homeotropic alignment, parallel planar alignment, anti-parallel planar alignment, hybrid alignment and twisted planar alignment.

19. The display according to claim 1, wherein the display has a single viewing plane which contains a display normal or the display has two principle viewing planes which are perpendicular and both contain the display normal, and wherein absorption axes of the entrance polarizer and the exit polarizer are substantially parallel or perpendicular to each other.

20. The display according to claim 1, wherein the additional optical element has complete translational symmetry in one direction parallel to the liquid crystal layer, and absorption axes of the entrance polarizer and the exit polarizer are each aligned either substantially parallel to or perpendicular to an axis of translational symmetry of the additional optical element.

21. The display according to claim 20, wherein the additional optical element includes an array of lenticular lenses, a striped parallax barrier or a louvre.

22. The display according to claim 1, wherein the additional optical element provides additional functionality of dual, 3D, or privacy view.

23. The display according to claim 1, wherein the additional optical element provides improved display performance with respect to brightness and/or saving power

24. The display according to claim 1, wherein the additional optical element includes a microlens array, refractive optics, louvre, parallax barrier or diffractive optics.

25. A liquid crystal display, comprising:
a combination including a liquid crystal layer located between an entrance polarizer and an exit polarizer;
a backlight configured to illuminate the combination on a side of the liquid crystal layer which includes the entrance polarizer for viewing by an observer on a side of the liquid crystal layer which includes the exit polarizer;
an additional optical element which is positioned on the side of the liquid crystal layer which includes the exit polarizer and is configured to provide additional functionality and/or improved display performance in the display,
wherein the liquid crystal layer is maintained between an entrance substrate and an exit substrate, a compensation film is situated between the exit substrate and the liquid crystal layer, and the exit polarizer is an internal polarizer located between the compensation film and the exit substrate.
